(19) United States
(12) Patent Application Publication
(10) Pub. No.: US 2005/0003723 A1
(43) Pub. Date: Jan. 6, 2005

(54) Shear and water resistant felt pad for furniture legs

(76) Inventors: Marcel Brouard, Levis (CA); Raymond Perron, Levis (CA)

Correspondence Address: Paul Biron, P.O. Box 0732, Jackman, ME, 04945-0732, US

(21) Appl. No.: 10/652,651

(22) Filed: Sep. 2, 2003

(30) Foreign Application Priority Data
Jul. 4, 2003 (CA) 2,433,557

(51) Int. Cl. B32B 27/04; B32B 5/02; B32B 27/12

(52) U.S. Cl. 442/86; 442/320; 442/321; 442/324

(57) ABSTRACT

A felt pad made for application under the leg of a piece of furniture. This floor protector (20) is used to protect the floor from scratches caused by the furniture displacement. The superior face (26) is infused by an adhesive, instead of the two-sided adhesive tapes (60) which are known. The way the adhesive is infused renders the complete surface of the superior face adherent, which improves the felt pad resistance to shear efforts. It is also much more resistant to water. This innovative felt pad is replaceable when the adhesive is injected unto the upper face (38) of a mushroom-shaped Velcro surface, instead of directly to the superior face of a felt pad. Henceforth, a felt pad may be removeably fixed to the Velcro surface and replaced after wear. In this way, one may change only the felt pad, without having to remove the persisting adhesive below the leg. The felt pad used is in three stages: the top (42) and bottom (46) surfaces being made of felt, while the center stage (48) is reinforced.

### FIELD OF THE INVENTION

This invention relates to the field of pads to be used underneath the legs of furniture to protect floors from scratches caused by the movement of furniture. Most particularly, this invention relates to replaceable pads and shear resistant pads designed to last longer.

### DESCRIPTION OF PRIOR ART

The use of felt pads for protecting floors is common and widely used. However, many of such pads are installed to the bottom of the legs of furniture using a double-sided adhesive tape, further, such pads have a weakness toward shear constraints where they tend to tear. The following Patents and Patent Applications Publications illustrate such concepts.

U.S. 10/152,660 Hanes; A replaceable protection system where the adhesive used is a double sided adhesive tape, and wherein a plurality of loops are incorporated to the felt material in order to be fixed to a velcro consisting of hook shaped members.

CA 2029911 Dumas May 15, 1992; A floor protector made to be inserted in hollow furniture legs.

CA 2351594 Allan Nov. 17, 1999; A floor protector made of a hardened material such as plastic, which is screwed under the legs of the piece of furniture.

### BACKGROUND OF THE INVENTION

A general objective of the invention is to provide a pad for application under the leg of a piece of furniture in order to protect the floor from scratches that may be caused by the displacement of this furniture. Specifically, we wanted the pad to be adaptable to different sizes of furniture legs which possess a flat surface underneath, in contact with the floor. The prior art comprises of many ways to achieve these goals. However, the main problems with the existing pads is their lack of resistance to shear efforts, lack of durability and poor resistance to the application of water such as when cleaning the floors. The inventors found a way to provide a pad that is further resistant in the three manners explained. In this way we produced a felt pad with a hardened upper layer in which an adhesive film is infused to a uniform upper surface.

Further, we realized as in Hanes (Ser. No. 10/152,660) that once one achieves good durability another problem soon comes up: if the material that constitutes the pad becomes contaminated with external particles, these particles eventually build up and may become a cause for scratches to the floors. In this case, it is usually advantageous to change the soft pad for a new one. If the adhesive substance used to secure the pad to the bottom of the furniture leg provides the shear resistance needed, it is often hard to remove and tends to leave a persisting film on the bottom of the leg. The operation of changing the pad henceforth becomes an unpleasant burden. As in Hanes, we decided to offer a means to install a base to which may be installed an interchangeable pad. Our base consists of a shear resistant mushroom shaped velcro to which the adhesive is infused to the back face to provide a uniformly smooth adhesive surface. Further, the improved pad consists of two soft sides with a reinforced middle section providing a shear resistant pad.

### BRIEF DESCRIPTION OF THE DRAWINGS

The drawings illustrate an embodiment of the invention.

FIG. 1a is a perspective view of the pad seen from the top;

FIG. 1b is a perspective of the pad of FIG. 1a seen from the bottom.

FIG. 2a is an alternative to the pad of FIG. 1b, seen from the bottom.

FIG. 2b is a detailed view of the pad of FIG. 2a seen from the top.

FIG. 2c is an enlarged view of the pad of FIG. 2b once assembled.

FIG. 3a shows a front view of the prior art.

FIG. 3b shows a front view of the pad of FIG. 2a.

### DETAILED DESCRIPTION OF THE DRAWINGS

In the following description the bold numbers refer to items illustrated in the drawings.

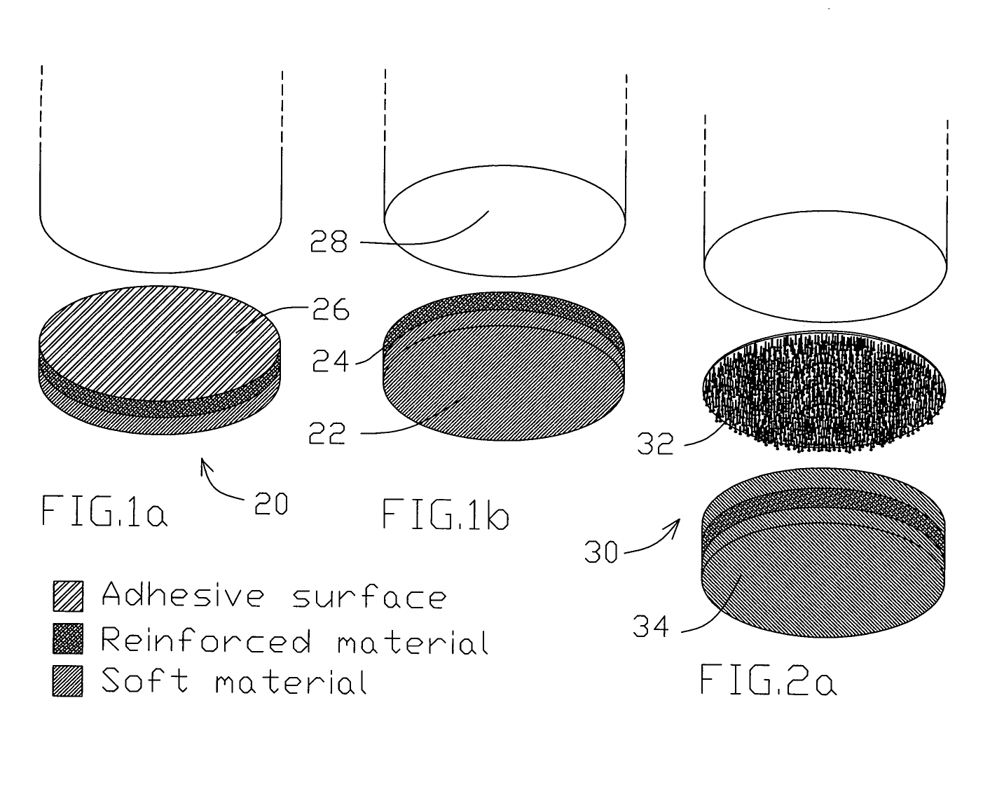

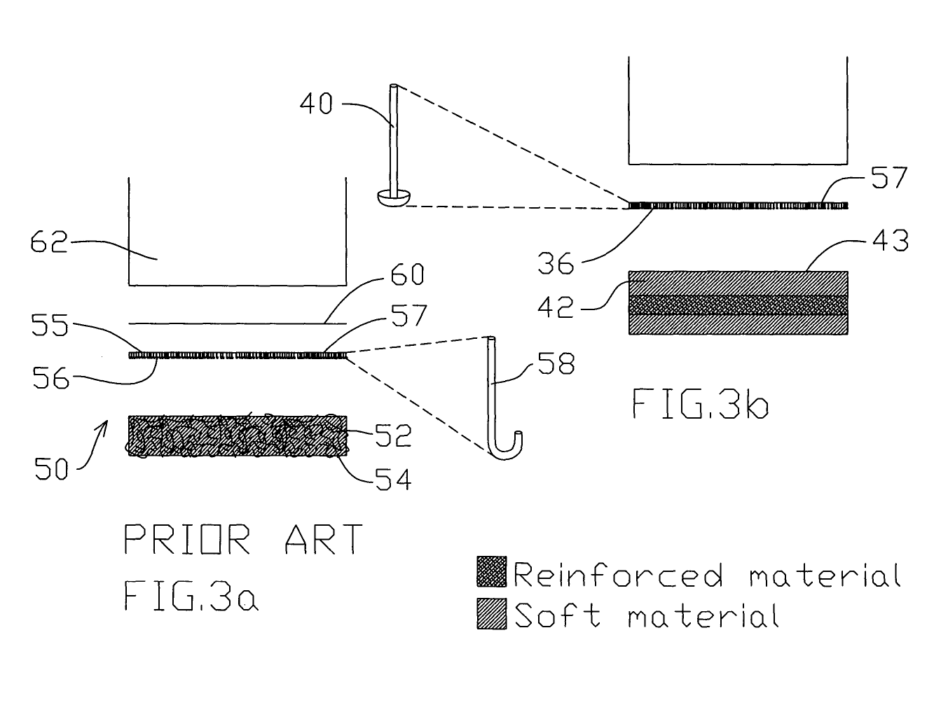

Note: FIGS. 1 et 2 both show a pad having an adhesive incorporated side and another side which is soft and can slide on a surface without damaging it. FIGS. 3a and b illustrate the differences between the present innovation and the prior art.

FIG. 1a shows a permanent protector pad 20 which may be built with an inferior surface 22 made of soft material, and a reinforced upper section 24, preferably reinforced by the infusion of a resin in the fibrous material of the pad. The upper section comprises an adhesive upper surface 26, wherein the adhesive is preferably incorporated by injection in the upper surface of the superior section of the pad, in the reinforced material, in a way to provide an even upper adhesive surface. In FIG. 1a the pad is shown viewed slightly from the top whereas in FIG. 1b the pad is shown viewed slightly from the bottom.

FIG. 1b also shows the general shape of the bottom of the leg 28 of a piece of furniture underneath which may be installed the pad.

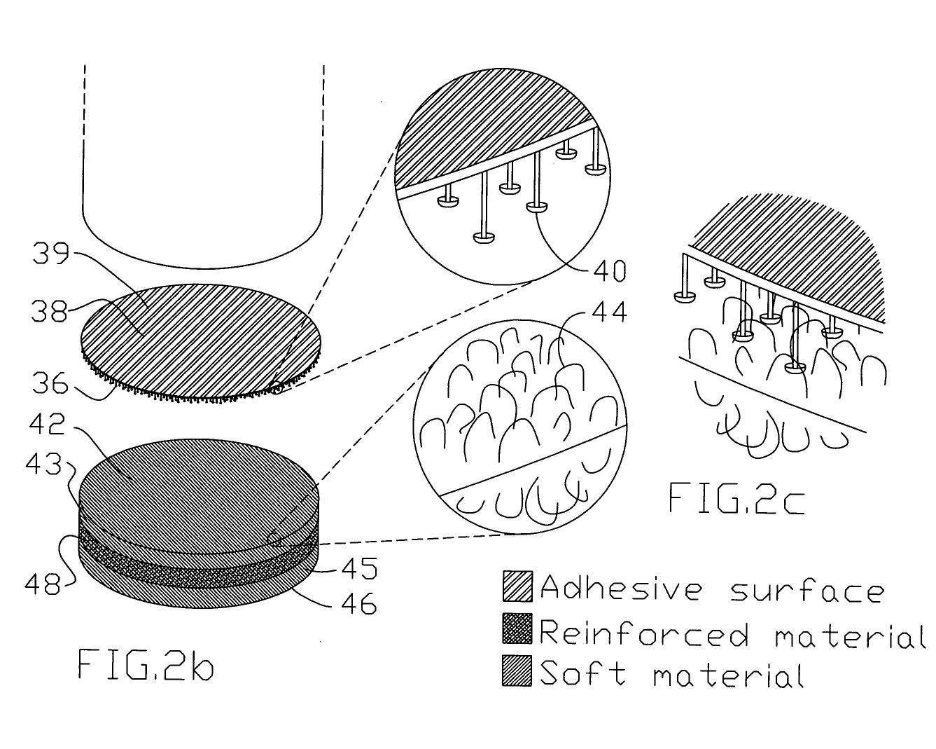

FIG. 2a shows a perspective view of a replaceable protector pad 30 shown slightly from the bottom and composed of two pieces: a fixed base 32 and a replaceable sole 34.

FIG. 2b shows a perspective viewed slightly from the top where one can see two enlarged windows showing the material of the sole and the material of the base. In the main view, one can see that the base is made of a fabric 38 underneath which is a grabbing material 36 and on top of which is incorporated an adhesive substance in a way to provide an even upper adhesive surface 39. The grabbing material consists of a mushroom-like 40 velcro type material consisting of many mushroom-like grabbing members.

The sole 34 is made of three sections: a superior section 42 made of a material comprising fibers 44 forming arches which will be restrained by the mushroom-like members in a way that the sole may be fixed upon the base. The sole also comprises a bottom section 46 made of a soft material that may slide without damaging floor surfaces. The sole also comprises a middle section 48 which is made of a firm material. This way the complete sole is much more resistant to shear stress constraints. Typically, in the bottom and top sections felt may be used as material. It is also possible to build the sole material by joining two sheets of felt using a heat process at the surfaces which are in contact. In this way, the center material melts and then hardens, constituting the firmer center section material. In production both sheets of felt are unrolled and approach each other gradually. At the moment of junction, a flame causes the fibers at the surface of the contact surfaces to melt and join, and then harden. This type of felt has a better shear resistance than the original material, and gives a stronger resistance to the entire assembly. This is very important for a long lasting protector pad.

FIG. 2c shows an enlarged view of the side of the sole fixed to the base. The mushroom-like grabbing members restrain the fibers of the soft upper section from being removed, especially during shear stress. The sole fixed in this way is particularly resistant to shear constraints, however, a relatively light constraint in the tension direction permits the removal of the sole for replacement after normal wear.

FIG. 3a shows the pad of the prior art 50 which is made of three parts: a fibrous pad 52 reinforced with stronger fibers 54, a hook material with a grabbing inferior section 56 comprising hooks members 58, an irregular uneven superior fabric surface 57 and a double sided adhesive tape 60.

We found the problem with this construction is that the adhesive tape is only in contact with a fraction of the upper surface because this surface is irregular. Since it is embossed, only the fraction of the surface which is elevated keeps contact with the tape. Furthermore, since the upper surface of the protector pad is porous, water, soap and humidity may infiltrate and attack the adhesive tape when the pad is exposed to such elements in events such as mopping of the floors. The adhesive tape is very weak against water and has a tendency to lose its adhesion either to the pad or to the underneath of the furniture legs as soon as it is moistened. This may lead to the loss of the protective pad and to floor damage when the loss goes unnoticed. This is why a strong, durable and water-resistant adhesion is not only important to protect floors, but critical.

The felt may break down in layers or by pieces. In order to reinforce the felt sole in the prior art model, stronger fibers 54 are added to the typical felt material 52. These stronger reinforcing fibers are firmer than felt and therefore may damage the floor surface noticeably if it is slided repeatedly. It will not damage the surface as the furniture legs might but may however produce a long term sanding effect. This is why we found it is imperative to provide a lower surface made entirely of soft material.

FIG. 3b shows an application of the present invention: the fact of reinforcing the sole only at its center 48 leaves pure material to slide on the surfaces without damage while keeping an increased overall shear strength. This also permits the upper surface material 42 to be grabbed by the mushroom-shaped grabbing members 36. The incorporation of the adhesive is achieved in the fabric of the base, it makes the superior surface even so the entire surface is exposed to adhesion to the furniture leg. This also reduces the quantity of pores in the material, and therefore limits the infiltration of water. Furthermore, the use of mushroom-shaped grabbing members instead of the hook-shaped ones gives a great increase in shear effort resistance. Overall, this protector pad is much stronger against shear efforts and against humidity and water.

Ramifications

During experimentation, the inventors have been confronted to several problems: first of all, the protector pad needed to be resistant to shear strength. Many prior art pads were installed under furniture legs using a double sided adhesive tape. The problem with this installation was that the tape did not adhere well to the fibrous matter of a felt pad. For example, imagine installing tape on a carpet, only the fibers are in contact with the tape and these fibers account only for a relatively small fraction of the carpet total surface area. This has two consequences:
The first one is the lack of resistance to shear efforts: the protector pad installed in this way has a tendency to leave the bottom of the furniture leg which sometimes causes many scratches to the floor before we realize it left. Furthermore, the porous material was very weak against water, which makes its way through the pad to attack the adhesive tape. The adhesive tape loses most of its adhesive qualities when wet.
The second consequence is that when distributed, this adhesive tape is often installed to the pad and covered by a protector layer. Once in a while, when trying to remove the protector layer we actually removed the adhesive tape from the pad or even a layer of felt. This left the pad unusable.

Another problem often encountered with prior art is that a soft material like felt (which is often used) usually does not offer a very good resistance to shear strength. The material itself often had a tendency to break down by layers or otherwise deform, especially when moving heavy furniture over uneven floors. This is a cause for premature wear of the protector pad.

We found a way to overcome these problems: we inject a material which hardens in the superior section of the pad. This makes the pad much stronger to shear efforts and less vulnerable to wear while permitting the pad to conserve its softness on the lower section.

An adhesive is then injected on the superior surface which is now incorporated with a hardened material (latex for example) which gives it a surface which is much less porous. Since the surface is also more straight and even, the adhesive is now secured to a strong base and is in contact with the entire surface area of the pad. All the problems which were referred to earlier are solved with this procedure. The water has much more trouble making its way to the adhesive; the protector layer covering the adhesive when distributed will be easy to remove and the adhesive bond holding the pad to the bottom of a furniture leg is now very strong.

So strong in fact that it became difficult to replace the pad after the soft material of the pad came into contact with impurities. This is where we had another idea: make the pad replaceable. Velcro was a good candidate because it already attached itself very well to a material such as felt. Therefore, several experiments were made and it was found that the best type of velcro to be used was the one in which the grabbing material had a head in the shape of a mushroom instead of the one in which the shape was simply the one of a hook. The mushroom shapes offer a form of hook which is equally strong all around, on 360 degrees. They tend to grab more than one fiber at a time. Hence, they are resistant to shear effort applied in any direction and stay easy to change when an effort is applied in tension. To give an idea of the strength, the following experience was realized:
A piece of velcro material having the approximate dimensions of one inch wide and where one inch long was installed on a felt surface and where the rest exceeded the felt material as to provide a gripping surface was pulled sideways by an average male adult. When done using a velcro material with hook shaped members, a strong pull was sufficient to remove the velcro strap from the felt material. However, when using a velcro material with mushroom shaped members, even a strong pull from an average male adult was not sufficient to release the strap from the felt.

To keep the good qualities achieved with the one-piece protector pad, a few transformations followed. The adhesive is now directly injected to the porous surface of the back face of the velcro grabbing material in a way to form an even adhesive film surface to the face which will be installed to the bottom of the furniture legs. Secondly, the center of the felt pad is now reinforced instead of the superior section in order to leave an upper surface which may be grabbed by the velcro members, and a lower surface which is soft and delicate to protect the finish of the floors from scratches. An inexpensive way to achieve this center reinforcement is to use a heating process to join two sheets of felt material by surfaces which are put into contact. Since only the bottom of the upper sheet and the top of the bottom sheet are melted and joined by the heat process, the top and bottom sections of the resulting material keep the desired characteristics.

Presently, we use a polyester felt in the fabrication of our preferred protector pads. However, the use of a felt made from natural materials is presently investigated to provide an earth-friendly biodegradable product. Other materials may also prove to be advantageous to use in certain applications.

It is to be clearly understood that the instant description with reference to the annexed drawings is made in an indicative manner and that the preferred embodiment described herein is meant in no way to limit further embodiments realizable within the scope of the invention. The matter with is claimed as being inventive and new is limited only by the following claims.

Parts List

20—Permanent protector pad
22—Soft inferior surface
24—Reinforced upper layer
26—Adhesive superior surface
28—Furniture leg
30—Replaceable protector pad
32—Fixed base
34—Replaceable sole
36—Grabbing material
38—Upper material with adhesive
39—Uniform adhesive surface
40—Grabbing mushrooms
42—Upper layer
43—Upper felt sheet
44—Fibers forming arches
45—Lower felt sheet
46—Lower layer
48—Central layer
50—Prior art
52—Felt
54—Strong fibers
55—Grabbing fabric
56—Grabbing surface
57—Uneven upper face
58—Hooks
60—Double sided adhesive tape
62—Furniture leg

1. A protector pad for use with a piece of furniture with legs, the pad being constituted of a flat body of a certain thickness and compring two pad faces:
a lower pad face (22) which is soft, destined to slide against delicate surfaces without scratching them and
an upper pad face wherein an adhesive is injected as to render its surface even, said second pad face destined to be fixed to the bottom of said leg of said piece of furniture.

2. The protector pad of claim 1 made of a porous material wherein the volume of said flat body comprises two regions: a first upper region (24) where the porous material is infused with a hardening material, and a second lower region, said regions being delimited by an imaginary center plane; the upper surface of said upper region forming said upper pad face and the bottom surface of said lower region forming the lower pad face (22).

3. The protector pad of claim 2 wherein said infused material is latex.

4. The protector pad of claim 2 wherein said porous material is either felt from synthetic materials such as polyesther or felt from natural materials rendering the pad more biodegradable and earth-friendly.

5. The protector pad of claim 1 wherein said flat body is constituted of two pieces, each having a certain thickness: a base (32) and a sole (34); the base comprising a fabric (38) with a superior face forming the said upper pad face and wherein an inferior face comprises first means for assembly; the sole comprises an inferior layer whose inferior face forms said lower pad face (22) and a superior layer with a superior face comprising second means for assembly; said means for assembly destined to assemble said sole to said base.

6. The base of claim 5 wherein said first means of assembly constitute of a number of grabbing members (36).

7. The base of claim 6 wherein said fabric is a mushroom-type velcro (36) wherein said grabbing members are mushroom shaped grabbing members (36).

8. The sole of claim 5 wherein second means of assembly (42) comprises fibers forming arches (44).

9. The sole of claim 8 wherein the material of said upper layer is felt in which the fibers form said arches.

10. The sole of claim 9 wherein said felt material consists either of polyester or natural fibers.

11. The sole of claim 5 comprising also a center layer (48) in addition to said layers, said center layer constituted of a reinforced material.

12. The sole of claim 5 wherein said superior (42) and inferior (46) layers are made of felt material.

13. The sole of claim 12 wherein said felt material consists either of polyester or natural fibers.

14. The sole of claim 11 wherein said superior (42) and inferior (46) layers are made of felt material and wherein said reinforced material is hardened felt obtained by making the sole material from two sheets of felt put into contact and where the region of contact is exposed to heat thus temporarily melting the surface felt which hardens once both sheets are in contact.
